(19) United States
(12) Patent Application Publication
(10) Pub. No.: US 2025/0125109 A1
(43) Pub. Date: Apr. 17, 2025

(54) SECURITY DEVICE WITH MAGNET ARRAY

(71) Applicant: Magnasphere Corporation, Waukesha, WI (US)

(72) Inventors: Joseph C. Hedeen, Menomonee Falls, WI (US); James H. Wise, Valparaiso, IN (US)

(21) Appl. No.: 18/916,269

(22) Filed: Oct. 15, 2024

Related U.S. Application Data
(60) Provisional application No. 63/544,279, filed on Oct. 16, 2023.

(51) Int. Cl. H01H 36/00

(52) U.S. Cl. CPC H01H 36/0073

(57) ABSTRACT

A magnetic switch apparatus for detecting relative movement between first and second members includes a switch assembly and a magnetic actuator. The switch assembly is mounted on the first member and is configured to shift between a first state and a second state. The magnetic actuator is mounted on the second member and is configured to shift the switch assembly between the first state and the second state when the first member and the second member are in the open position. The magnetic actuator includes a first magnet, a second magnet, and a third magnet. The first magnet has a first magnetic polarity orientation, the second magnet has a second magnetic polarity orientation, and the third magnet is located between the first and second magnets and has a third magnetic polarity orientation that is different than the first and second magnetic polarity orientations.

### CROSS-REFERENCE TO RELATED APPLICATIONS

The current patent application is a non-provisional utility patent application which claims priority benefit, with regard to all common subject matter, of earlier-filed U.S. Provisional Application Ser. No. 63/544,279; entitled “FLOOR MOUNT SECURITY DEVICE”; and filed Oct. 16, 2023. The Provisional Application is hereby incorporated by reference, in its entirety, into the current non-provisional patent application.

### BACKGROUND

An alarm system uses a sensor or magnetic switch attached to a door or window for detecting unauthorized opening thereof. A magnetic switch generally includes a switching component that physically shifts, which switches states of an alarm circuit, based on a relative position of an actuating magnet. The magnetic switch is generally secured to a frame of the opening, and the actuating magnet is secured the door or window sash. Some magnetic switches are subject to unauthorized manipulation through the use of a strong external defeat magnet. That is, in some circumstances, an intruder can place a strong magnet in proximity to a magnetic switch to hold it in a certain position to prevent it from switching the state of the alarm circuit.

Accordingly, there is a real unsatisfied need in the art for improved high security and other alarm switch assemblies that inhibit tampering and defeat magnets.

The background discussion is intended to provide information related to the present invention and is not necessarily prior art.

### SUMMARY OF THE INVENTION

The present invention helps to solve the above-described problem and other problems by providing magnetic switch apparatuses for detecting relative movement between members with relatively stronger magnetic actuators that enable relatively stronger biasing devices on switch assemblies to prevent defeat magnets from holding the states of the switch assemblies.

A magnetic switch apparatus constructed according to an embodiment of the present invention detects relative movement between a first member and a second member from a closed position wherein the first member and the second member are proximal, and an open position wherein the first member and the second member are separated. The magnetic switch apparatus includes a switch assembly and a magnetic actuator. The switch assembly is operable to be mounted on the first member and is configured to shift between a first state and a second state. The magnetic actuator is operable to be mounted on the second member and is configured to shift the switch assembly between the first state and the second state when the first member and the second member are in the open position. The magnetic actuator includes a first magnet, a second magnet, and a third magnet. The first magnet has a first magnetic polarity orientation, the second magnet has a second magnetic polarity orientation, and the third magnet is located between the first and second magnets and has a third magnetic polarity orientation that is different than the first and second magnetic polarity orientations.

A magnetic switch apparatus constructed according to another embodiment of the invention detects relative movement between a first member and a second member from a closed position wherein the first member and the second member are proximal, and an open position wherein the first member and the second member are separated. The apparatus includes a switch assembly and a magnetic actuator. The switch assembly is operable to be mounted on the first member and is configured to shift between a first state and a second state. The magnetic actuator is operable to be mounted on the second member and is configured to shift the switch assembly between the first state and the second state when the first member and the second member are in the open position. The magnetic actuator includes three or more magnets forming a Halbach array.

A magnetic switch apparatus constructed according to another embodiment detects relative movement between a first member and a second member from a closed position wherein the first member and the second member are proximal, and an open position wherein the first member and the second member are separated. The apparatus includes a switch assembly and a magnetic actuator. The switch assembly is operable to be mounted on the first member and is configured to shift between a first state and a second state. The magnetic actuator is operable to be mounted on the second member and is configured to shift the switch assembly between the first state and the second state when the first member and the second member are in the open position. The magnetic actuator includes three or more magnets arranged to define a recess and forming a magnetic field with a magnetic flux distribution external to the three or more magnets being concentrated in the recess.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is an elevational view of a door protected by a magnetically actuated surface-mounted alarm assembly in which embodiments of the invention may be implemented;

FIG. 2 a schematic diagram depicting an exemplary circuit configuration of a security switch of the alarm assembly of FIG. 1;

FIG. 3 is a sectional view of an exemplary magnetically actuatable switch forming a part of the surface-mounted alarm assembly of FIG. 1;

FIG. 4 is an enlarged, fragmentary view illustrating the sections of the surface-mounted alarm assembly of FIG. 1;

FIG. 5 is a schematic diagram depicting a magnetic actuator of the alarm assembly of FIG. 1 constructed according to an embodiment of the present invention;

FIG. 6 is a schematic diagram of a magnetic actuator constructed according to another embodiment of the present invention and having a housing complementary to a housing of the switch;

FIG. 7 is a schematic diagram of a magnetic actuator constructed according to another embodiment of the present invention, wherein a magnetically actuatable switch includes a pair of magnetic flux concentrators;

FIG. 8 is a schematic diagram of a magnetic actuator constructed according to another embodiment of the present invention in which the magnetic actuator includes magnets arranged in a staggered position;

FIG. 9 is a schematic diagram of a magnetic actuator constructed according to another embodiment of the present invention in which the magnetic actuator includes magnets arranged to form a recess for receiving the switch;

FIG. 10 is a lowered elevational view of the magnetic actuator of FIG. 9;

FIG. 11 is a raised elevational view of the magnetic actuator of FIG. 9;

FIG. 12 is a schematic diagram of a magnetic actuator constructed according to another embodiment of the present invention in which the magnetic actuator includes magnets arranged to form a recess, the magnetic actuator being in an open position relative to the switch;

FIG. 13 is a schematic diagram of the magnetic actuator of FIG. 12 with the magnetic actuator being in a closed position relative to the switch; and

FIG. 14 is a flowchart depicting exemplary steps of a method according to an embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the present technology can include a variety of combinations and/or integrations of the embodiments described herein.

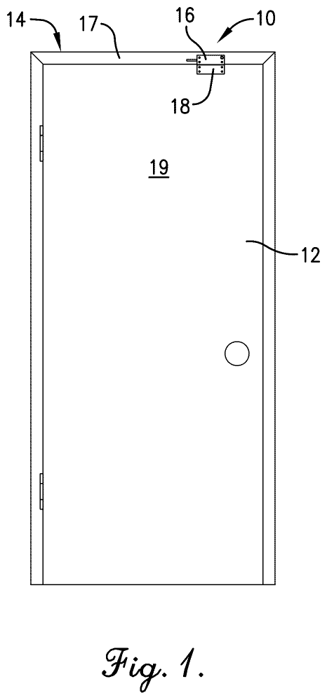

Turning now to FIG. 1, a magnetic switch apparatus 10 is illustrated in operative position for protecting a first member, such as a door 12, mounted in a second member, such as a doorframe 14. The magnetic switch apparatus 10 broadly includes a switch or sensor assembly 16 mounted on the outer surface 17 of doorframe 14, as well as a magnetic actuator 18 mounted on the adjacent outer surface 19 of the door 12. Broadly, the apparatus 10 is designed to trigger an alarm upon unauthorized opening of the door 12. While the switch assembly 16 is depicted as being mounted on the doorframe 14 and the magnetic actuator 18 on the door 12, the switch assembly 16 may be mounted on the door 12, and the magnetic actuator 18 may be mounted on the doorframe 14 without departing from the scope of the present invention. Additionally, the first and second members may be any structure capable of relative movement, including a window, cabinet, drawer, or the like.

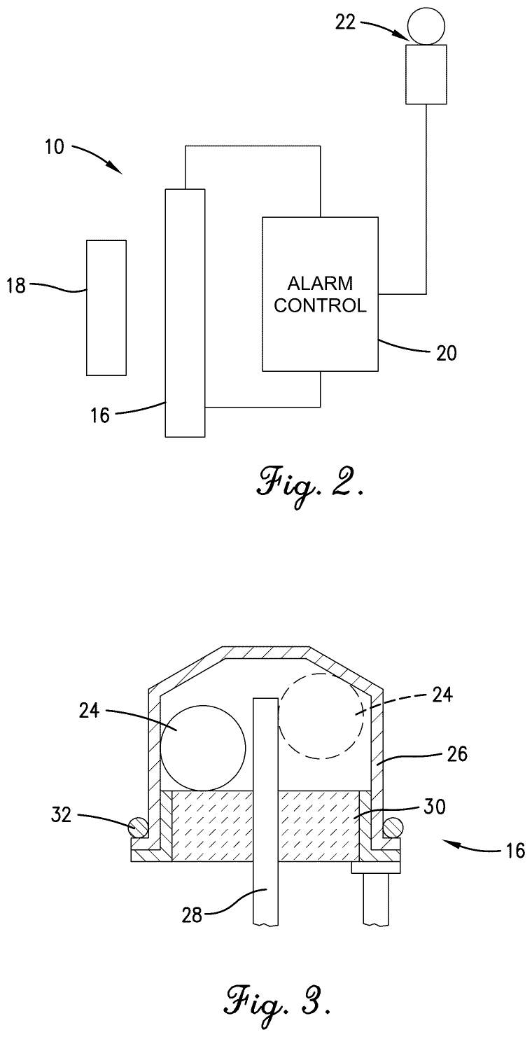

Turning to FIG. 2, in one or more embodiments, the switch assembly 16 may be connected to control circuitry 20 that is configured to trigger an external device 22, such as an alarm (including an audio and/or visual alarm), a computer, a smart phone, or the like. In one or more embodiments, the control circuitry 20 is configured to detect a state of the switch assembly 16 and send a signal when the switch assembly 16 is in a particular state and/or switches states. However, the control circuitry 20 may include any logic without departing from the scope of the invention. The control circuitry 20 may include processors, microprocessors (single-core and multi-core), microcontrollers, DSPs, field-programmable gate arrays (FPGAs), analog and/or digital application-specific integrated circuits (ASICs), or combinations thereof. The control circuitry 20 may generally execute, process, or run instructions, code, code segments, software, firmware, programs, applications, apps, processes, services, and/or daemons. The control circuitry 20 may also include hardware components such as finite-state machines, sequential and combinational logic, and other electronic circuits that can perform the functions necessary for the operation of the current invention. The control circuitry 20 may be in communication with the other electronic components, including the external device 22, through wired or wireless communication, including through serial or parallel links that include address busses, data busses, and/or control lines.

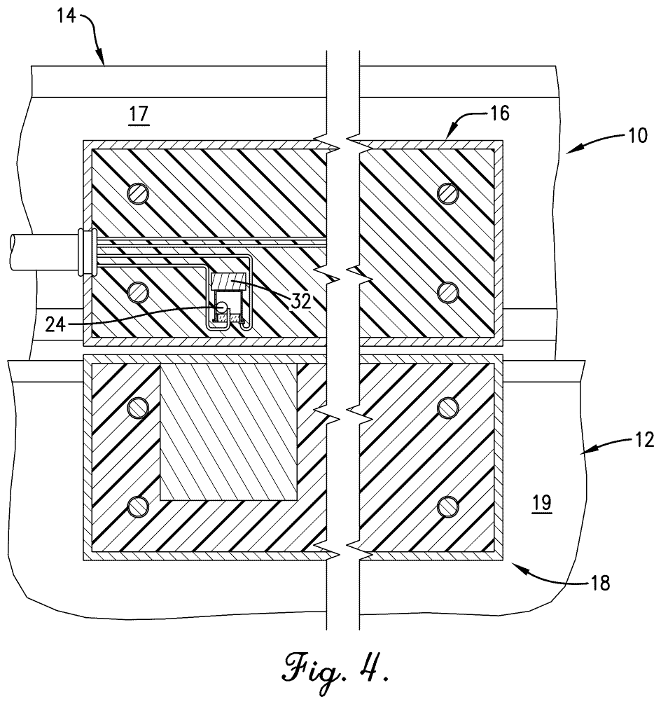

Turning to FIG. 3, in one or more embodiments, the switch assembly 16 comprises a magnetically actuatable ball switch of the type illustrated and described in FIG. 3B of U.S. Pat. No. 8,487,726, which is hereby incorporated by reference herein. The switch assembly 16 includes a magnetically susceptible object 24 positioned in a switch housing 26 made of conductive material. A conductive contact 28 extends into the housing 26 and is isolated from the housing 26 via insulative material 30. The conductive contact 28 and the housing 26 may be connected to portions of the control circuit 22. The object 24 is shiftable so that it touches both the contact 28 and the housing 26 in one position, which may present a close circuit, thereby indicating the position of the object 24. However, other means of detecting the position of the object 24 may be used without departing from the scope of the present invention. While the object 24 is depicted as being a ball, it may have any shape without departing from the scope of the present invention. In one or more embodiments, the switch assembly 16 includes a biasing element 32, such as a ferromagnetic biasing ring, that biases the object 24 in one state, such as in a position where it does not touch the contact 28, unless the magnetic actuator 18 is proximal to the switch assembly 16, as shown in FIG. 4. In one or more embodiments, the biasing ring 32 is a soft magnet that attracts the object 24, thereby pulling it to the upper outer corner but weak enough to allow the magnetic actuator 18 to pull it to the bottom of the switch assembly 16, thereby closing the circuit. In one or more embodiments, the biasing ring 32 is a brass ring plated with around one to five micro-inches of nickel, which is ferromagnetic. The switch assembly 16 may be any type of magnetic switch or sensor without departing from the scope of the present invention. For example, the switch assembly 16 may be a reed switch, a magnetically actuatable ball switch, a hall transistor, a magnetoresistive sensor, a magnetostrictive sensor, a magneto-optical sensor, or the like.

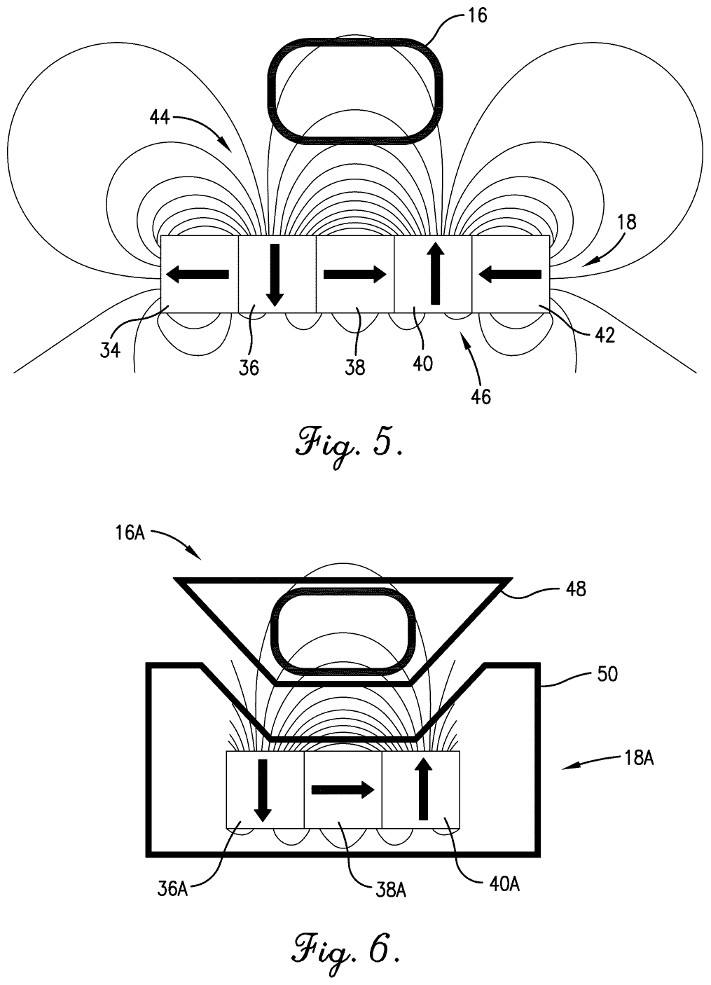

Turning to FIG. 5, the magnetic actuator 18 constructed according to an embodiment of the present invention is schematically depicted in a proximal position relative to the switch assembly 16. In one or more embodiment, the magnetic actuator 18 comprises a plurality of magnets 34, 36, 38, 40, 42 with at least some of them arranged in a Halbach array. In one or more embodiments, the magnets 34, 36, 38, 40, 42 are all aligned so that when the actuator 18 and switch assembly 16 are in a closed position, the magnets 34, 36, 38, 40, 42 are spaced apart from a longitudinal axis of the switch assembly 16 at the same distance. The arrows on the magnets 34, 36, 38, 40, 42 in FIG. 5 represent their respective magnetic polarity orientations, which generally signify the magnetic field extending from the conventional “south pole” to the “north pole”. The magnets 34, 36, 38, 40, 42 may include any type of magnet without departing from the scope of the present invention, including electromagnets, permanent magnets, ring magnets, or the like, or a combination thereof. Further, the magnetic actuator 18 may have any number of magnets without departing from the scope of the present invention.

As shown in FIG. 5, the magnetic polarity orientations of the magnets 34, 36, 38, 40, 42 vary and may be at angles, or are oblique, relative to magnetic polarity orientations of the other magnets. In one or more embodiments, the magnets 34, 36, 38, 40, 42 are arranged so that their respective magnetic polarity orientations are shifted in a counterclockwise direction from left to right. This arrangement forms a magnetic field (represented by the field lines) with a magnetic flux density (external to the magnets) that is generally higher on the side 44 of the array proximal to the switch assembly 16 when in a relatively closed position compared to the other opposite side 46. While the magnetic polarity orientations of the magnets 34, 36, 38, 40, 42 are depicted as being at angles of around ninety degrees relative to one another, the relative orientations may be any angle without departing from the scope of the present invention.

In one or more embodiments, the magnet 38 located at the center of the array of the magnetic actuator 18 has a magnetic polarity orientation that extends parallel to a longitudinal length of the actuator 18 and/or magnetic switch assembly 16 when in the closed position. The magnetic polarity orientation of the middle magnet 38 may further be parallel to an external surface of the respective member 12 to which it is attached. However, the middle magnet 38 may have any number of orientations without departing from the scope of the present invention, including one in which its magnetic polarity orientation extends toward the switch assembly 16 when in the closed position, as described in further detail below.

A magnetic actuator 18A constructed in accordance with another embodiment of the invention is shown in FIG. 6. The magnetic actuator 18A may comprise substantially similar components as magnetic actuator 18; thus, the components of magnetic actuator 18A that correspond to similar components in magnetic actuator 18 have an ‘A’ appended to their reference numerals. The principal difference between magnetic actuator 18A and magnetic actuator 18 is that magnetic actuator 18A only has three magnets 36A, 38A, 40A and the magnetic actuator 18A and switch assembly 16A have housings 48, 50 that are complementary to one another. As shown, the magnetic polarity orientations of the magnets 36A, 38A, 40A are shifted relative to one another in a counterclockwise direction from left to right to form a Halbach array.

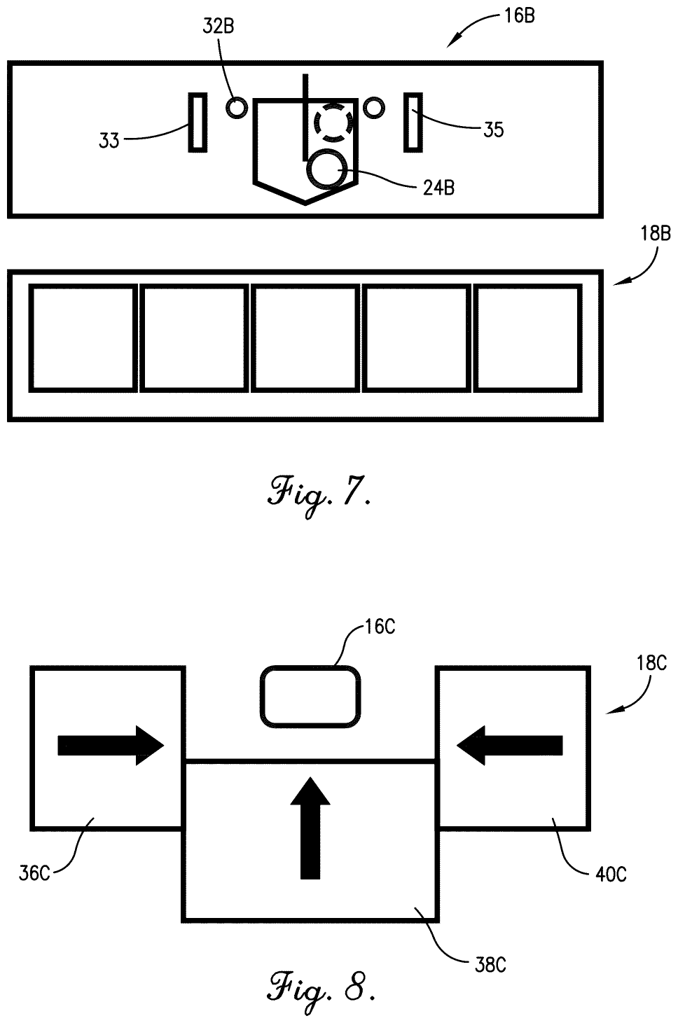

A magnetic switch assembly 16B constructed in accordance with another embodiment of the invention is shown in FIG. 7. The magnetic switch assembly 16B may comprise substantially similar components as magnetic switch assembly 16; thus, the components of magnetic switch assembly 16B that correspond to similar components in magnetic switch assembly 16 have a ‘B’ appended to their reference numerals. The principal difference between magnetic switch assembly 16B and magnetic switch assembly 16 is that the magnetic switch assembly 16B includes a pair of magnetic flux concentrators 33, 35. FIG. 7 depicts a cross-sectional view of the magnetic flux concentrators 33, 35. In one or more embodiments, the magnetic flux concentrators 33, 35 are ferromagnetic plates placed on either side of the object 24B. In one or more embodiments, one or more of the magnetic flux concentrators 33, 35 are ring or washer-shaped ferromagnetic plates. Similarly, in one or more embodiments, the magnets of the magnetic actuator 18B are arranged to form a Halbach array.

A magnetic actuator 18C constructed in accordance with another embodiment of the invention is shown in FIG. 8. The magnetic actuator 18C may comprise substantially similar components as magnetic actuator 18; thus, the components of magnetic actuator 18C that correspond to similar components in magnetic actuator 18 have a ‘C’ appended to their reference numerals. The principal difference between magnetic actuator 18C and magnetic actuator 18 is that two or more of the magnets 36C, 38C, 40C of the magnetic actuator 18C are located at different horizontal distances relative to a longitudinal axis of the switch assembly 16C when in the closed position.

The outer magnets 36C, 40C may be positioned relatively closer to the longitudinal axis of the switch assembly 16C. The middle magnet 38C is positioned farther away from the longitudinal axis so that it is in a staggered position. The magnets 36C, 38C, 40C define a space for receiving at least a portion of the switch assembly 16C. Further, the magnetic polarity orientation of the middle magnet 38C extends towards the switch assembly 16C when in the closed position. However, the other magnets 36C, 40C are still arranged so that the magnets 36C, 38C, 40C form a Halbach array.

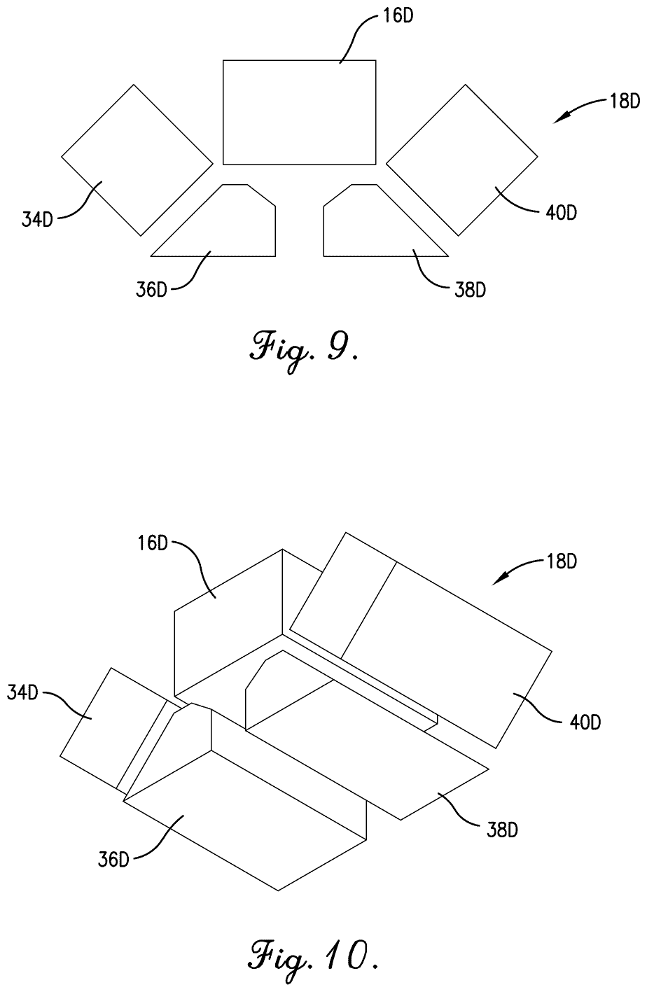

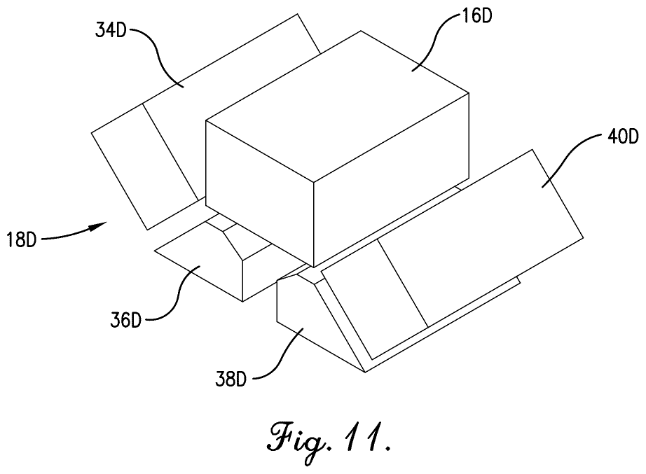

A magnetic actuator 18D constructed in accordance with another embodiment of the invention is shown in FIGS. 9-11. The magnetic actuator 18D may comprise substantially similar components as magnetic actuator 18; thus, the components of magnetic actuator 18D that correspond to similar components in magnetic actuator 18 have a ‘D’ appended to their reference numerals. The principal difference between magnetic actuator 18D and magnetic actuator 18 is that magnetic actuator 18D includes four magnets 34D, 36D, 38D, 40D having varying shapes and arranged to define a cavity for receiving a portion of the switch assembly 16D.

In one or more embodiments, the four magnets 34D, 36D, 38D, 40D have magnetic polarity orientations that vary in accordance with a Halbach array. The outer magnets 34D, 40D are rectangular prisms, and the inner magnets 36D, 38D are irregular 5-sided prisms. However, the magnets 34D, 36D, 38D, 40D may have any shape without departing from the scope of the present invention.

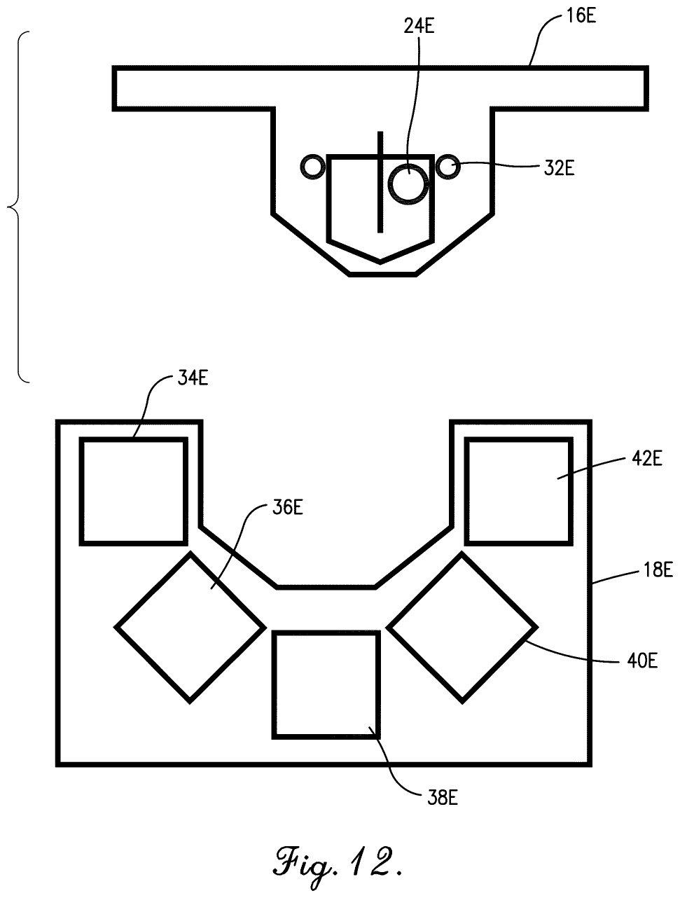

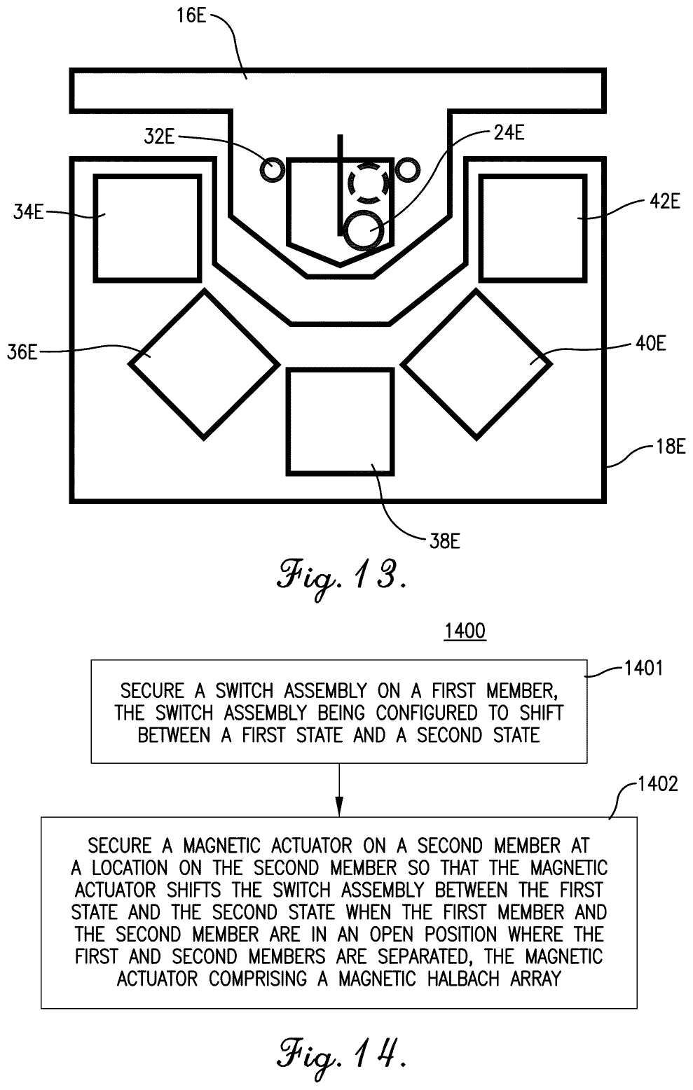

A magnetic actuator 18E constructed in accordance with another embodiment of the invention is shown in FIGS. 12 and 13. The magnetic actuator 18E may comprise substantially similar components as magnetic actuator 18; thus, the components of magnetic actuator 18E that correspond to similar components in magnetic actuator 18 have an ‘E’ appended to their reference numerals. The principal difference between magnetic actuator 18E and magnetic actuator 18 is that the magnets 34E, 36E, 38E, 40E, 42E of the magnetic actuator 18E are arranged to define a recess that receives the switch assembly 16E. In one or more embodiments, the magnetic polarity orientations of the magnets 34E, 36E, 38E, 40E, 42E arranged to form a Halbach array. The magnets 34E, 36E, 38E, 40E, 42E are also arranged so that their respective inner faces all face a central point in the recess.

FIG. 12 depicts the switch assembly 16E and the magnetic actuator 18E being at an open position in which the switch assembly 16E and the magnetic actuator 18E are separated. The biasing ring 32E biases the magnetically susceptible object 24E upwards. FIG. 13 depicts the switch assembly 16E and the magnetic actuator 18E being at a closed position in which the switch assembly 16E and the magnetic actuator 18E are proximal to one another. In the closed position, at least a portion of the switch assembly 16E extends into the recess defined by the magnets 34E, 36E, 38E, 40E, 42E. The magnetic field produced by the magnets 34E, 36E, 38E, 40E, 42E overcomes the field formed by the biasing ring 32E to pull the object 24E down away from the biased position (represented by the circle with dashed lines).

The flow chart of FIG. 14 depicts the steps of an exemplary method 1400 of mounting a magnetic switch apparatus for detecting relative movement between a first member and a second member. In some alternative implementations, the functions noted in the various blocks may occur out of the order depicted in FIG. 14. For example, two blocks shown in succession in FIG. 14 may in fact be executed substantially concurrently, or the blocks may sometimes be executed in the reverse order depending upon the functionality involved. In addition, some steps may be optional. The method 1400 is described below, for ease of reference, as being executed with exemplary devices and components introduced with the embodiments illustrated in FIGS. 1-13.

Referring to step 1401, the switch assembly is secured to the first member. The first member may be a door, doorframe, window, window frame, or the like. As discussed above, the switch assembly is configured to shift between first and second states. The switch assembly may include one or more magnetic ball switches with one or more biasing rings for biasing the magnetically susceptible object thereof in a biased position. In one or more embodiments, the switch assembly is positioned to protrude from the first member so that it is operable to extend into a recess of a magnetic actuator.

Referring to step 1402, the magnetic actuator containing a plurality of magnetics arranged in a Halbach array is secured to the second member. The magnetic actuator is arranged on the second member so that when the first and second members are proximal, the magnetic field formed by the Halbach array causes the switch assembly to switch states. In one or more embodiments, the magnetic actuator is arranged on the second member so that when the first and second members are in the closed position or proximal to one another, a recess of the magnetic actuator receives at least a portion of the switch assembly.

The method 1400 may include additional, less, or alternate steps and/or device(s), including those discussed elsewhere herein.

### ADDITIONAL CONSIDERATIONS

Although the present application sets forth a detailed description of numerous different embodiments, it should be understood that the legal scope of the description is defined by the words of the claims set forth in any subsequent regular utility patent application. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112 (f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed, and substitutions made herein without departing from the scope of the invention as recited in the claims.

Having thus described various embodiments of the invention, what is claimed as new and desired to be protected by Letters Patent includes the following:

1. A magnetic switch apparatus for detecting relative movement between a first member and a second member from a closed position wherein the first member and the second member are proximal, and an open position wherein the first member and the second member are separated, the magnetic switch apparatus comprising:
a switch assembly for mounting on the first member and configured to shift between a first state and a second state; and
a magnetic actuator for mounting on the second member and configured to shift the switch assembly between the first state and the second state when the first member and the second member are in the open position, the magnetic actuator comprising:
a first magnet having a first magnetic polarity orientation,
a second magnet having a second magnetic polarity orientation, and
a third magnet located between the first and second magnets and having a third magnetic polarity orientation that is different than the first and second magnetic polarity orientations.

2. The magnetic switch apparatus of claim 1, wherein at least one of the first magnet, the second magnet, or the third magnet is a permanent magnet.

3. The magnetic switch apparatus of claim 1, wherein the switch assembly is a magnetically actuatable ball switch.

4. The magnetic switch apparatus of claim 1, wherein the third magnetic polarity orientation is angled relative to the first magnetic polarity orientation along a first direction.

5. The magnetic switch apparatus of claim 4, wherein the second magnetic polarity orientation is angled relative to the third magnetic polarity orientation along the first direction.

6. The magnetic switch apparatus of claim 5, wherein the third magnetic polarity orientation is at an angle of ninety degrees relative to the first magnetic polarity orientation along the first direction, and the second magnetic polarity orientation is at an angle of ninety degrees relative to the second magnetic polarity orientation along the first direction.

7. The magnetic switch apparatus of claim 1, wherein the third magnetic polarity orientation extends parallel relative to a longitudinal length of the magnetic actuator.

8. The magnetic switch apparatus of claim 1, wherein the third magnetic polarity orientation extends transverse relative to a longitudinal length of the magnetic actuator.

9. The magnetic switch apparatus of claim 1, wherein the first magnet, the second magnet, and the third magnet form a magnetic field with a first magnetic flux density on a first side and a second magnetic flux density on a second side that is lower than the first magnetic flux density, and the first side faces the switch assembly when the first and second members are proximal.

10. The magnetic switch apparatus of claim 1, the first magnet, the second magnet, and the third magnet form a Halbach array.

11. The magnetic switch apparatus of claim 1, wherein the first magnet and the second magnet are positioned at a first distance from a longitudinal axis of the switch assembly when in the closed position.

12. The magnetic switch apparatus of claim 11, wherein the third magnet is at the first distance from the longitudinal axis of the switch assembly when in the closed position.

13. The magnetic switch apparatus of claim 12, wherein the third magnet is adjacent to the first magnet, and the second magnet is adjacent to the third magnet.

14. The magnetic switch apparatus of claim 11, wherein the third magnet is positioned at a second distance from the longitudinal axis of the switch assembly when in the closed position, the second distance being longer than the first distance.

15. A magnetic switch apparatus for detecting relative movement between a first member and a second member from a closed position wherein the first member and the second member are proximal, and an open position wherein the first member and the second member are separated, the magnetic switch apparatus comprising:
a switch assembly for mounting on the first member and configured to shift between a first state and a second state; and
a magnetic actuator for mounting on the second member and configured to shift the switch assembly between the first state and the second state when the first member and the second member are in the open position, the magnetic actuator comprising three or more magnets forming a Halbach array.

16. The magnetic switch apparatus of claim 15, wherein the switch assembly comprises at least one of a magnetically actuatable ball switch, a hall transistor, a magnetoresistive sensor, a magnetostrictive sensor, a reed switch, or a magneto-optical sensor.

17. The magnetic switch apparatus of claim 15, wherein at least one of the three or more magnets is a permanent magnet.

18. A magnetic switch apparatus for detecting relative movement between a first member and a second member from a closed position wherein the first member and the second member are proximal, and an open position wherein the first member and the second member are separated, the magnetic switch apparatus comprising:
a switch assembly for mounting on the first member and configured to shift between a first state and a second state; and
a magnetic actuator for mounting on the second member and configured to shift the switch assembly between the first state and the second state when the first member and the second member are in the open position, the magnetic actuator defining a first side facing the switch assembly when in the closed position and comprising three or more magnets arranged to have different relative magnetic polarity orientations to form a magnetic field with a magnetic flux distribution external to the three or more magnets being concentrated on the first side.

19. The magnetic switch apparatus of claim 18, wherein the magnetic actuator includes five or more magnets.

20. The magnetic switch apparatus of claim 18, wherein the three or more magnets are arranged to define a recess, and each of the three or more magnets has a first magnetic pole and a second magnetic pole opposite the first magnetic pole, the second magnetic pole extending toward the recess.
